(19) United States
(12) Patent Application Publication
(10) Pub. No.: US 2007/0189001 A1
(43) Pub. Date: Aug. 16, 2007

(54) MULTI-FUNCTIONAL BALLAST AND LOCATION-SPECIFIC LIGHTING

(75) Inventors: Lyman O. Nielson, Williams, AZ (US); Norman B. Hess, Fruit Heights, UT (US)

Correspondence Address: MADSON & AUSTIN;GATEWAY TOWER WEST, SUITE 900, 15 WEST SOUTH TEMPLE, SALT LAKE CITY, UT, 84101, US

(73) Assignee: SAFEexits, Inc., Fruit Heights, UT (US)

(21) Appl. No.: 11/738,909

(22) Filed: Apr. 23, 2007

Related U.S. Application Data
(63) Continuation-in-part of application No. 11/435,945, filed on May 17, 2006.
Application No. 11/435,945 is a continuation-in-part of application No. 10/733,853, filed on Dec. 11, 2003, now Pat. No. 7,086,747.
(63) Continuation-in-part of application No. 11/455,604, filed on Jun. 19, 2006.
(60) Provisional application No. 60/432,562, filed on Dec. 11, 2002.
(60) Provisional application No. 60/692,117, filed on Jun. 20, 2005.

(51) Int. Cl. G03B 15/02

(52) U.S. Cl. 362/16

(57) ABSTRACT

An energy-efficient lighting apparatus that includes a lighting fixture. The lighting fixture includes a multi-functional ballast and one or more fluorescent lights. The lighting fixture may also operate one or more fluorescent lamps. One or more light emitting diodes (LEDs) may also be used. The LEDs may be located on the ballast tray cover or on any illuminating surface of the fixture and may also be located remote from the ballast. The one or more LEDs are in low-voltage communication with the ballast. The ballast allows the system to switch from a high voltage setting (which is used when the fluorescent lights are illuminated) to low voltage setting (which is used when the LEDs are illuminated). This lighting system provides work/task lighting for the users of the building.

### CROSS-REFERENCED RELATED APPLICATIONS

This application is a continuation-in-part of prior U.S. patent application Ser. No. 11/435,945 (filed May 17, 2006), which is a continuation-in-part of U.S. Pat. No. 7,086,747 (filed Dec. 11, 2003), which claims the benefit of U.S. Provisional Patent Application Ser. No. 60/432,562 (filed Dec. 11, 2002). This application also is a continuation-in-part of U.S. patent application Ser. No. 11/455,604 (filed Jun. 19, 2006), which claims the benefit of U.S. Provisional Application No. 60/692,117 (filed Jun. 20, 2005). All of these prior patents/patent applications are expressly incorporated herein by reference.

### BACKGROUND OF THE INVENTION

1. The Field of the Invention

The present invention relates to systems for lighting an area. More specifically, the present invention relates to a lighting system that may be used to provide low voltage lighting to a specific location, yet also provide emergency lighting, security lighting, low-level night lighting, or other lighting needs.

2. The Relevant Technology

For about one hundred years, electric lights and lighting systems have been routinely used in buildings, offices, and residences. In fact, building safety codes now mandate that lights and lighting systems be part of the building. Thus, any commercial or residential building presently used in the United States should have some type of lights or lighting systems.

One of the most widely used light fixtures in both commercial buildings and residential buildings are the so-called fluorescent lights. Fluorescent lights are generally long, thin cylinders that may be illuminated to provide efficient lighting to a particular area, especially larger rooms or areas. Accordingly, many building owners often use fluorescent lights as a means of saving electricity and/or money.

As lighting systems have progressed, other types of lighting systems have also been developed to address specific lighting needs. For example, “emergency” (or “egress”) lighting systems have been developed to increase the safety of buildings. These systems usually include incandescent or halogen lights that are powered by battery backup systems. Specifically, these systems are designed such that these lights will turn on in the event that there is a power outage or other type of emergency. If an emergency or power outage occurs, the emergency lights of these systems illuminate the building and indicate to the building-occupants where the exits are located. Hopefully, by following the indications provided by the emergency lights, the occupants will then be able to efficiently and safely find the appropriate hallways, stairways, etc. that will lead them out of the otherwise dark building. Such emergency lights have the further advantage in that they may also provide light so that rescue personnel (such as firefighters, etc.) can enter and navigate through the building quickly and efficiently.

Most people believe that the inclusion of such emergency lighting system will increase the overall safety of the building. Thus, most building safety codes mandate that all commercial buildings (including office buildings, theaters, stores, etc.) have emergency lighting systems. Emergency lights, however, are not presently required for most residential buildings.

In addition, many homeowners have also desired additional lighting systems to function as night lighting systems (which are sometimes called “nightlights”). These lights are generally plugged into an electrical outlet and are designed such that during the night (or in other periods of darkness), these lights will provide low-level lighting to an area. Although the amount of light provided by these nightlights is generally small, these nightlights do provide sufficient light so that a person can walk in the area without colliding with the furniture, walls, etc. Parents of small children often purchase such nightlights if their child is “afraid of the dark” or as a way of preventing injury to their child if the child gets up in the night (such as to go the bathroom, to get a drink of water, etc.). Night lighting systems may also be used to assist elderly persons in navigating hallways, rooms, etc. during the night.

Finally, owners of both commercial and residential buildings have begun using lighting systems as part of the buildings' security system. Generally, these lighting systems (which are sometimes called security lighting systems) are programmed so that multiple lights, in different parts of the house or building, will switch on and off at different times of the day. Usually, these security systems will use a timer that is attached to one or more floor lamps such that these lamps will turn on and off at desired times of the day. Hopefully, by turning these lights on and off at selected times, a would-be perpetrator will believe that someone is actually present in the building and will be deterred from trying to vandalize/rob the building. In some situations, commercial building owners may use less than the full compliment of fluorescent lights to provide security/egress lighting.

Additional information regarding emergency lighting systems, security lighting systems, and/or night-lighting systems may be found in the following patents/patent applications listed above.

While the above-described lighting systems are generally effective in accomplishing their purpose, such systems are often difficult to install and/or expensive to operate. Moreover, most present systems do not have any way to combine emergency lighting systems with security lighting systems and/or night lighting systems. Further, while fluorescent lights provide “global” lighting for large rooms/areas, many people like optional, location-specific lighting at a person's desk, proximate or over a computer, in a stairwell, over a door, etc. If such location-specific, optional lighting is required, the person must purchase expensive lamps (or other secondary light sources) to provide this optional light source. These secondary light sources often require incandescent light bulbs, and are thus expensive to operate.

Accordingly, there is a need in the art for a new type of lighting system that is inexpensive to use and operate. This lighting system will likely include fluorescent lights to take advantage of the cost-savings that are associated with these efficient lighting features. Likewise, there is a need in the art for a lighting system that may be used as an emergency lighting system, a night lighting system, and as a security lighting system. Further, this new lighting system should also provide a person with the ability to provide optional lighting to a specific area, such as proximate a computer, in a stairwell, etc., without requiring the user to purchase lamps or other secondary light sources. Additionally, this lighting system may incorporate a new type of multi-functional ballast that allows the use of both light emitting diodes (LEDs) and fluorescent lights. Such a device and system is disclosed herein.

### BRIEF SUMMARY OF THE INVENTION

An energy-efficient lighting apparatus is disclosed. This lighting apparatus comprises a lighting fixture that includes a multi-functional ballast and one or more fluorescent lights. The lighting fixture may be designed to receive and/or hold the fluorescent lights. A ballast tray cover may also be used as part of the lighting fixture. One or more LEDs (light emitting diodes) may also be added to the lighting apparatus.

The one or more LEDs may also be designed such that they are capable of being activated independently of the one or more fluorescent lights. In some embodiments, the lighting apparatus is constructed such that a user may turn on/off the LEDs and fluorescent lights via (radio frequency) RF controls. This RF control may be a wall switch or may be a handheld user. Of course, it is expressly noted that the present application is not limited to RF controls. Any other type of controls or switches may be used to turn the LEDs or the fluorescent lights on/off may be used in conjunction with the present embodiments. Thus, as used herein, RF controls are but an example of the type of control/switch that may be used. Thus, a user may use the RF controller to turn on the LEDs, if the user desires LED light in the area. If the user desires fluorescent light, the user may use the RF control to turn off the LEDs and turn on the fluorescent lights. This RF control may also be used to turn all lights off (i.e., to turn off both the fluorescent lights and the LEDs).

In some embodiments, the LEDs are positioned on the light fixture (such as on the ballast tray cover). In other embodiments, the LEDs may be located remote from the multi-functional ballast. The LEDs being located “remote from the ballast” means that the LEDs are not positioned on the ballast tray cover. Rather, in these embodiments, the LEDs are external LEDs that may be positioned along the ceiling, floor, or wall of a room. Such external LEDs may be connected to the multi-functional ballast via one or more leads. Other embodiments may be designed such that each LED is positioned at the end of a lead. In some embodiments, there will not be any LEDs on the light fixture itself, rather, all of the LEDs will be external of the light fixture so that they are located over work stations, hallways, stairwells, etc. Having no LEDs in the light fixture may allow the user to maximize the number of LEDs distributed in the workspace and may be used to provide work/task lighting.

The LEDs may also be connected to the multi-functional ballast to provide low-voltage light. The LEDs receive power which will cause the LEDs to illuminate. As LEDs generally consume less electricity/power than other types of lights, these light sources are generally referred to as being “low-voltage.” In further embodiments, the LEDs will receive wireless signals from the multi-functional ballast (or other portions of the lighting fixture) which cause the LEDs to illuminate.

In some embodiments, the energy-efficient lighting apparatus may be designed such that the multi-functional ballast may be switched between high voltage and low voltage. Further embodiments are designed in which the multi-functional ballast switches between high voltage for the fluorescent lights and low voltage for the LEDs.

Embodiments may also be constructed in which the energy-efficient lighting apparatus further comprises a battery for supplying power to the LEDs. A battery charging circuit for charging the battery may also be added. A switching circuit may also be used. The switching circuit couples the battery to the LEDs if it is determined that the switching circuit is not receiving AC voltage from an AC voltage source. Further embodiments may be designed in which the switching circuit will operate to couple the battery to the LEDs if an alarm signal is being received.

Yet further embodiments may be designed in which the LEDs are housed within a housing that will fully or partially conceal the LED. However, when the LED is turned on, the LED will “pop-out” or unsheathe. Of course, the housing that conceals the LED will be visually appealing and will match the décor of the room. Thus, until the LEDs are actually used, the LEDs will be completely (or partially) “out of the way.” Yet, at the same time, the LED will pop-out and provide illumination during an emergency based upon the user's controls, etc. The ‘pop out’ fixture may direct light to the floor and will be installed near the floor. When the LED is no longer providing illumination it will return into the housing for storage, protection, etc.

The present embodiments may also teach a method for providing illumination to an area in an energy-efficient manner. This method comprises the step of providing a lighting fixture comprising a multi-functional ballast and one or more fluorescent lights. The step of positioning one or more LEDs remote from the ballast may also be added. Further, the step of configuring the one or more LEDs such that LEDs are in low-voltage communication with the ballast may also be performed. In this method, the one or more LEDs may be turned off while the fluorescent lights remain off (and vice versa). In other words, the multi-functional ballast is capable of switching between high voltage (for use with the fluorescent lights) and low voltage (for use with the LEDs). The method may further be designed such that a battery provides DC voltage to the LEDs if an AC voltage source fails to provide AC voltage to the ballast.

The present embodiments relate to a lighting apparatus that may be installed in rooms and buildings. These rooms may be part of an office building, a residential building, a school building, an apartment building, a house, a dwelling, or any other type of building. The present embodiments relate to an energy-efficient lighting apparatus that provides illumination (light) to the building. This lighting may be used to provide work/task lighting for individuals who are working, performing tasks, etc.

In some embodiments, the LEDs are positioned along the walls or the floor of the building. Further embodiments are designed in which the LEDs are positioned over employee workstations, thereby providing the employees with optional illumination for work/task lighting so that they can perform their jobs, comfortably work on their computers, etc. In further embodiments, the LEDs are positioned in the ceiling directly over the workstation, the person's computer, etc. It may also be possible to hang the LEDs downward, via a wire, such that they extend downward from the ceiling (and are thus positioned/suspended between the floor and the ceiling).

Individuals wanting to provide optional lighting to the building may also position LEDs along the wall or floor of the room. Leads that are behind the ceiling, wall, and/or the floor may connect these LEDs to the lighting fixture and allow the LEDs to receive power. Embodiments may be constructed in which a series of LEDs are positioned along the floor/wall to create a pathway that leads to a building exit (including the building's emergency exits, stairwells, fire escapes, windows, etc.) In the event of a power outage or emergency situation, the LEDs may illuminate to show the occupants the location of emergency exits, thereby helping the occupants properly and safely exit the building/room. Further, the LEDs may be designed to maintain illumination for multiple hours after the power is lost (or after the emergency condition is detected). If emergency personnel or firefighters enter the room, the LEDs will provide illumination/light to these persons, thereby facilitating the firefighters/emergency personnel in rescuing trapped individuals, avoiding obstacles, avoiding tripping hazards, avoiding dangerous conditions, and/or performing their emergency response/rescue duties.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic view of an exemplar area of a building that includes an example of a lighting apparatus according to the present embodiments;

FIG. 2 is a perspective view of an embodiment of a lighting fixture that may be used in the lighting apparatus of FIG. 1;

FIG. 2A is a block diagram that illustrates an example of the circuitry of a ballast according to the present embodiments;

FIG. 3 is a perspective view that illustrates an example of the way in which the present embodiments of a lighting apparatus may be use to provide illumination to a workstation;

FIG. 4 is a perspective view that illustrates an example of the way in which the present embodiments may be used to provide illumination proximate a wall or a floor of a room or over a door;

FIGS. 4A and 4B show an embodiment of an LED housed in a housing, wherein the LED may “pop-out” from the housing when it is being used and may return into the housing when it is not being used;

FIGS. 5A and 5B show an embodiment of an LED fixture that may be used in conjunction with the present lighting systems; and

FIGS. 6A and 6B show another embodiment of an LED fixture that may be used in conjunction with the present lighting systems.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

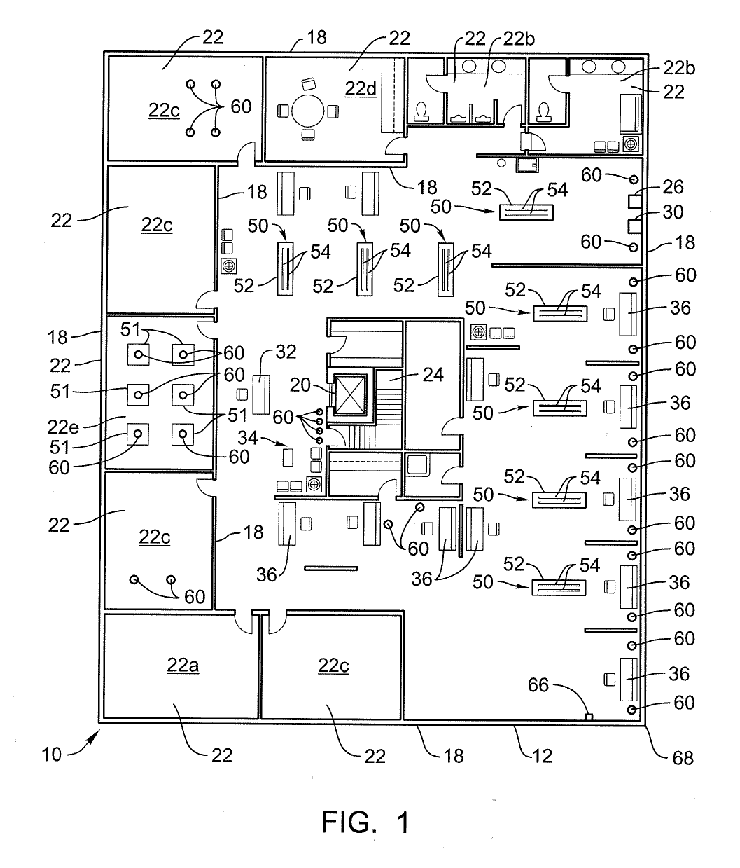

FIG. 1 is a schematic view of an exemplar planned area 10 of a building 12. In this Figure, the building 12 comprises an office and the specific planned area 10 comprises the first floor of this area. Accordingly, the planned area 10 includes various features that are common to the first floor of an office including walls 18, elevator 20, rooms 22, including storage room 22a and bathroom 22b, office 22c, break room 22d, and classroom (or meeting room) 22e. Stairs 24 may also be added so that the occupants of the building may go to another floor in the building 12. The stairs 24 may also function as an “emergency exit” as is required by most fire codes, building codes, earthquake codes, etc. A fire extinguisher 26 and/or one or more detectors 30 (which may be smoke detectors, carbon monoxide detectors, light sensors, etc.) may also be added. These detectors 30 and/or fire extinguishers 26 may also be required by the relevant building codes. A reception desk 32 may also be positioned proximate the elevator 20. The reception desk 32 is designed to house a receptionist or office manager. The reception desk 32 may be designed so that the receptionist can greet visitors or clients as they exit the elevator 20. A foyer 34 may also be found in the planned area 10. The foyer 34 is a waiting area for guests when they access the area 10. Other features/elements that are common to offices and/or office space may also be included as part of the planned area 10.

In the embodiment shown in FIG. 1, the planned area 10 includes one or more cubicles 36. The cubicles 36 are small workstations, which may include a telephone, a computer, desk space, file drawers, office supplies, a printer, or other standard office equipment. Each cubicle 36 may serve as the workspace for an office employee. Of course, other embodiments of the planned area 10 may be designed in which no cubicles are used. Rather, in these embodiments, each employee will have his or her own office (which is a separate room).

Those of skill in the art will also recognize that, although FIG. 1 shows the building 12 as an office, this depiction is given for illustrative purposes only. Other types of buildings may also be used. Specifically, in other embodiments, the building may comprise a house or dwelling, an apartment building, a multi-story building, a condominium, a store, a commercial building, a warehouse, a factory, a mall, or any other type of building that may be used for residential or commercial use. Likewise, although FIG. 1 shows the planned area 10 as being the first floor of the building, other embodiments may also be made in which the planned area 10 comprise office space, one floor of a multi-story building, a basement, etc. Still further embodiments may be constructed in which the planned area 10 comprises only a section or portion of a building floor, a few rooms in a building, etc. Yet further embodiments may be constructed in which the planned area 10 is a classroom or school (such as classroom 22e). In these embodiments, LEDs 60 may be above, at, or near one or more of the pupil's desks 51 to provide the students with sufficient work/task lighting to write, read, perform their assigned task, etc.

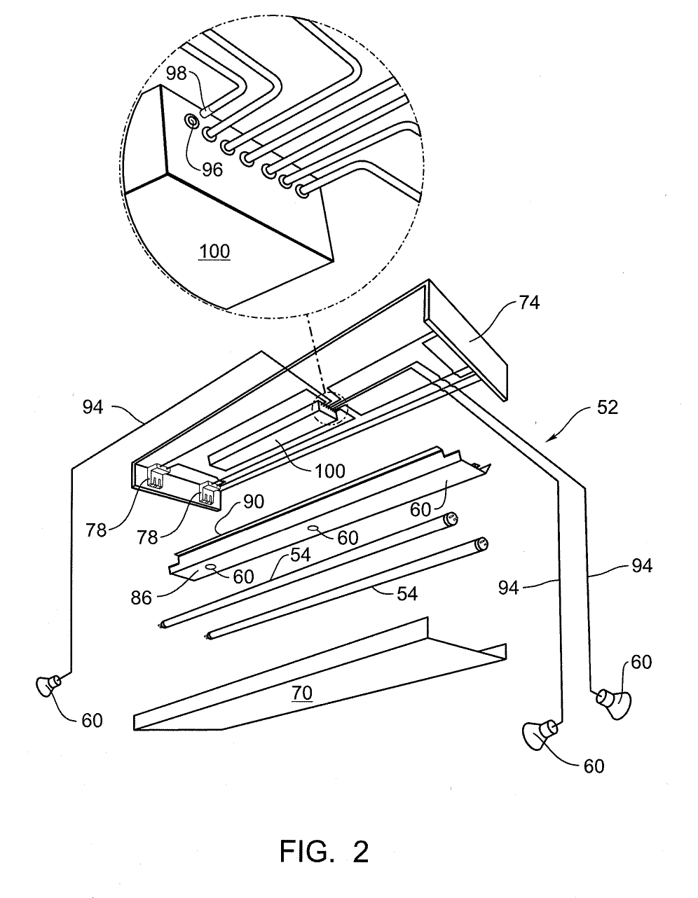

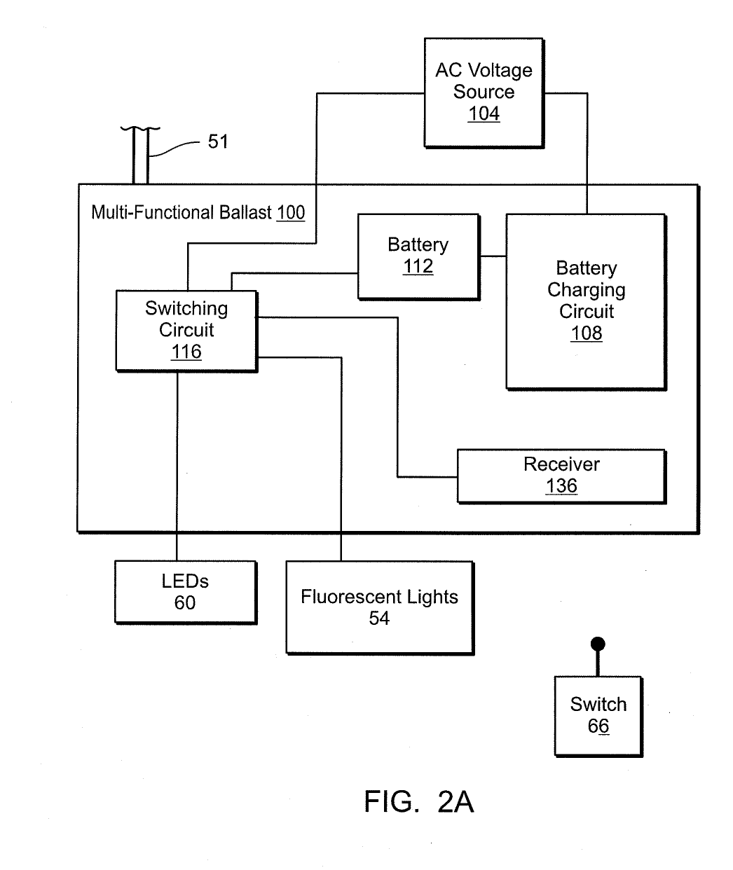

The planned area 10 includes an energy-efficient lighting apparatus 50 according to the present embodiments. More than one apparatus 50 may also be used. This lighting apparatus 50 is designed to provide illumination (light) to the planned area 10. The lighting apparatus 50 comprises a lighting fixture 52. The lighting fixture 52 includes one or more fluorescent lights 54. An example of the lighting fixture 52, as well as the fluorescent lights 54, that may be used in the planned area 10 are shown and described in FIG. 2. The lighting fixture 52 also includes a multi-functional ballast (shown in FIG. 2) used in conjunction with the fluorescent lights 54. The fluorescent lights 54 may be regular fluorescent lights, which are sometimes referred to as T12, T8, or T5 lamps.

These fluorescent lights 54 provide illumination to the planned area 10. In FIG. 1, only two light fixtures 52 are illustrated in the foyer 34. However, those of skill in the art will appreciate that the light fixtures 52 and/or the fluorescent lights 54 may be distributed (either uniformly or non-uniformly) throughout the planned area 10, including in the office(s) 22c, in the rooms 22, in the bathroom 22b, over the cubicles 36, in the stairwell 24, etc. The exact number and amount of the light fixtures 52 and/or fluorescent lights 54 used may depend on the size of the planned area 10, the amount of light desired/needed in the planned area 10, etc. Specific building codes may also mandate and/or influence the number and/or position of the light fixtures 52/fluorescent lights 54.

The lighting fixture 52 that is used to illuminate the planned area 10 may also include one or more light emitting diodes (LEDs) 60. The LEDs 60 may be located on the lighting fixture 52, such as on the ballast tray cover. The LEDs 60 may also be located external of the lighting fixture 52. In FIG. 1, the LEDs 60 are represented graphically by dots and are shown external of the lighting fixture 52. The LEDs 60 are located within the planned area 10. In some embodiments, the LEDs 60 may be positioned proximate the stairs 24, the fire extinguisher 26, over the cubicles 36, in the office 22c. In fact, any location in the planned area 10 in which the occupant desires additional or alternative lighting may be configured with one or more LEDs 60.

In some embodiments, one or more of the LEDs 60 may be positioned on the ceiling. Other embodiments may be designed in which one or more of the LEDs 60 is positioned along the walls 18 or the floor of the building 12. In further embodiments, the LEDs 60 are hung via a wire, such that they extend downward from the ceiling (and are thus positioned between the floor and the ceiling). Further embodiments are designed in which the LEDs 60 are positioned over the cubicles 36 or workstations of the various employees, thereby providing the employees with added illumination so that they can perform their jobs, work comfortably on their computers, etc. Other embodiments may also be designed such that multiple LEDs 60 are positioned, as desired, at the same employee workstation, thereby enabling the employee to have an LED 60 over the telephone, an LED 60 proximate the computer, an LED 60 over the printer, etc. Other embodiments may be designed for use in a classroom. In these embodiments, the LEDs 60 may be positioned over individual desks to provide location-specific lighting to each student.

It should be noted that the multi-functional ballast allows either the LEDs 60 or the fluorescent lights 54 to be illuminated. This is a function of the ability of the multi-functional ballast to switch between high voltage (for the fluorescent lights 54) and low voltage (for the LEDs 60). Thus, if a user desires fluorescent lights proximate his or her workstation, he will turn the fluorescent lights 54 via a switch. This switch may be an RF switch (or RF controller) that is mounted to the wall or is a separate, handheld device. In this configuration, the multi-functional ballast will operate at high voltage, which is requisite for the fluorescent lights 54. When the fluorescent lights 54 are illuminated, the LEDs 60 are turned off. However, if the user desires to use the LEDs 60, the user will use the switch to turn off the fluorescent lights 54 and turn on the LEDs 60. In turning on the LEDs 60, the multi-functional ballast switches to low voltage, which is requisite for the LEDs 60 and turns off the fluorescent lights 54. The user may also opt to turn off both the LEDs 60 and the fluorescent lights 54. Accordingly, the user has the ability to tailor the light provided to his or her workstation (or to a particular area of the planned area 10) by the lighting fixture 52.

In some embodiments, a single switch may be used to control a room of fixtures. In other words, a single switch may be used to control all of the light fixtures 52 in the planned area 10. In this embodiment, a user would turn on all of the fluorescent lights 54 and/or all of the LEDs 60 via the same switch.

In other embodiments, a switch may be used to control a distinct light fixture 52 in the planned area 10. In other embodiments, a single switch may be used to control a plurality of light fixtures 52, such as all of the light fixtures 52 in a hallway, all of the light fixtures 52 in a room 22, all of the fixtures 52 in a stairway, half (or a plurality) of the light fixtures 52 in the room, etc. In other embodiments, a separate switch may be used to control each distinct light fixture 52.

By having each specific light fixture 52 (or a small number of light fixtures) be controlled by separate switches, advantages may be achieved. For example, it is possible to construct embodiments in which each fixture 52 has its own multi-functional ballast that is controlled by a distinct switch. Each switch may be located at or near each person's cubicle 36/workstation (or each switch may be positioned at a “master location” such as in a storage room, etc.). In this system, a user could enter her cubicle 36 and could switch on only the light fixtures 52 proximate the workstation without affecting the other proximate light fixtures 52. Accordingly, each individual could tailor the lighting for their own desires. One user could, for example, work having the LEDs 60 proximate his cubicle 36 illuminated, whereas the worker in the adjacent cubicle 36 operates using fluorescent light 54 illuminated, and the worker in the next cubicle 36 have all of the light shut completely off. In other words, each user have the option of has ability to tailor lighting for their own needs or preferences via their own switch. If she or he chooses to work in darker conditions, they can either turn the lights completely off or choose to receive light only from the LEDs. This ability to turn the fluorescent lights 54/LEDs 60 on and off based upon the user's own preferences allows each user to customize the amount of light, thereby making the user's workstation more “user friendly.”

Even if the fluorescent lights 54 are turned on, an occupant may desire to have additional work/task lighting at the location proximate to his or her work station, computer, etc. Accordingly, such a building occupant may turn on one or more of the LEDs 60 located proximate his/her desk to provide additional illumination. In order to accomplish this, a system may be constructed that contains two or more of the multi-functional ballasts. If this embodiment is constructed, one of the multi-functional ballasts will control the fluorescent lights and a separate multi-functional ballast controls the LEDs.

It should be noted that LEDs 60 can be obtained in a variety of different illumination outputs. All of these different LEDs may be used as part of the present embodiments. Thus, if an occupant desires low-level lighting, a “dim” LED may be provided. However, other users that want higher levels of illumination, a brighter, more powerful LED may be used. Thus, occupants can further tailor the amount of light at a particular location in the planned area 10 by changing the output/brightness of the LED. Further tailoring of the illumination levels may be accomplished by varying the number of LEDs.

Further embodiments of the lighting apparatus 50 may also be designed such that individual lighting fixtures 52 and/or fluorescent lights 54 may be turned on or off separately from the other fluorescent lights 54. Thus, if a particular occupant wants greater illumination, he or she may turn on the lighting fixtures 52/fluorescent light 54 proximate their workstation (in addition to any proximate LEDs 60).

In order to allow each fluorescent light 54 and each LED 60 to be individually turned on or off, a switch 66 (such as an RF switch or other type of switch) may be positioned within the planned area 10. As explained above, the user will use this switch to turn the LEDs 60 and/or the fluorescent lights on and off. As shown in FIG. 1, only one switch 66 is shown. However, as explained above, multiple switches may be used. In fact, embodiments may be constructed in which each light fixture 52 has its own distinct switch 66. Further embodiments may be designed in which a switch 66 controls a plurality or “bank” of light fixtures 52.

This switch 66 may be located at any position within the planned area 10, as desired. However, in the embodiment shown in FIG. 1, the switch 66 may be mounted on a wall 18 proximate a corner 68. By positioning this switch 66 in this position, the switch 66 is readily accessible to the occupants, but at the same time, the switch 66 is also “out of the way.” The switch 66 may also be positioned proximate the cubicles 36. Of course, other embodiments may be designed in which the switch 66 is hidden in the storage room 22a, is positioned in or proximate to the foyer 34, is on a different floor of the building 12, or is otherwise positioned anywhere inside or outside of the building. In the embodiments where multiple switches 66 are used, these switches 66 may be mounted proximate each of the cubicles 36. In further embodiments, the switch(es) 66 are handheld devices.

In order to provide light to the planned area 10, the LEDs 60 and the fluorescent lights 54 must receive voltage from a voltage source. Generally, this voltage source is an AC voltage source (alternating current voltage source) that is present in modern buildings. However, as will be described in greater detail herein, one or more batteries (not shown in FIG. 1) may also be added to the lighting apparatus 50. These batteries may be “rechargeable” batteries that are configured such that the AC voltage from the building's AC voltage constantly charges the batteries. As such, the batteries are maintained at or near full capacity. In the event that AC voltage is lost to the building 12, the batteries will provide DC (direct current) voltage to illuminate the LEDs 60. AC voltage may be lost to the building 12 during a power outage, an emergency, etc. However, by including the batteries that illuminate the LEDs 60 during a power failure, sufficient light will be provided so that occupants may safely exit the building, if necessary. To facilitate the occupants in exiting the building, the LEDs 60 may be positioned proximate the exits, proximate the stairs 24, etc. and/or may form a pathway that leads/indicates the direction of the exits to the occupants.

As noted above, the planned area 10 also includes one or more detectors 30 that will detect whether there is an emergency condition, etc. Motion detectors (motion detectors detect people) may also be used as the detector 30. In the event that these detectors 30 indicate an emergency condition, a signal may be sent to the lighting apparatus 50 that will cause the LEDs to illuminate. Because the LEDs 60 have battery power (as described herein), these LEDs 60 may illuminate even if AC voltage is lost to the building 12 as a result of the emergency situation. The illumination of the LEDs 60 may assist the occupants in exiting the planned area 10 as it may illuminate the pathway(s) to the exits. In other embodiments, an LED 60 is positioned proximate a fire extinguisher 26. Accordingly, if the occupants need to use the fire extinguisher 26 during the emergency situation, there will be sufficient light so that the occupant can find and operate the fire extinguisher 26 properly. If the detector 30 is a motion detector, other embodiments may be designed. The motion detector is designed to sense movement of an occupant in an area. Embodiments may be designed in which the LEDs 60 will be illuminated, and in the event that the detector 30 senses motion, the LEDs 60 will be turned off and the fluorescent lights 54 will be turned on. Such embodiments are particularly suited for stairwells and/or other areas which require 24-hour illumination. In such embodiments, the LEDs 60 will provide the required 24-hour lighting. However, if the motion detector senses movement, the fluorescent lights 54 will be turned on. After the person has left, the fluorescent lights 54 will be turned off and the LEDs will be turned on. Thus, the less-expensive LEDs 60 will be operated the majority of the time, and the more expensive fluorescent lights 54 will only be turned on when a person is present. This system would result in a substantial energy savings and a substantial cost savings (such as, for example, a savings of about 85%).

The illumination of the LEDs 60 during an emergency condition may also facilitate firefighters or other emergency personnel who respond to the emergency. In some of the present embodiments, the batteries that provide voltage to the LEDs 60 may be designed such that the LEDs 60 will remain illuminated for at least multiple hours after the emergency condition is detected. (For example, the LEDs 60 may be illuminated by the batteries for a minimum of 90 minutes after loosing AC power). If firefighters or other emergency personnel are required to enter the building 12 during the emergency condition, the illumination provided by the LEDs 60 may allow the emergency personnel to enter building 12 and perform their emergency response or emergency rescue duties. In some embodiments, LEDs 60 may be positioned proximate the floor to provide firefighters or emergency response personnel a clearly illuminated path while they are walking through the building 12, thereby helping the emergency personnel avoid tripping over obstacles that may have been created by the emergency, etc.

Referring now to FIG. 2, an assembly view illustrates an example of the lighting fixture 52 with the fluorescent lights 54 that may be used in the present embodiments. As shown herein, the fluorescent lights 54 are long, thin cylinders that may be illuminated. Those of skill in the art will recognize that these fluorescent lights 54 are commercially available from a variety of different suppliers. A cover 70 may also be used to cover the fluorescence lights 54, thereby protecting the lights 54 and making the overall lighting fixture 52 more visually appealing. The cover 70 is, of course, optional.

A ballast tray 74 is also included as part of the lighting fixture 52. The ballast tray 74 is designed such that that fluorescent lights 54 may be placed within the ballast tray 74. The ballast tray 74 may include light sockets 78 (which are sometimes called “tombstones”) that are positioned on each end of the ballast tray 74. As is known in the art, the fluorescent lights may be positioned to engage the ballast tray 74.

A ballast cover 86 may also be added to the lighting fixture 52. (The ballast cover 86 is sometimes referred to as a “ballast tray cover”). The ballast cover 86 may be positioned between the fluorescent lights 54, when the lights 54 are positioned within the ballast tray 74. The ballast cover 86 may be designed to cover the wiring and/or electrical components of the ballast tray 74 when the ballast cover 86 is properly positioned. Such masking of the electrical components of the ballast tray 74 will increase the overall décor of the lighting fixture 52. In some embodiments, the ballast cover 86 may have a ledge 90 that engages the ballast tray 74 and allows the ballast cover 86 to “snap into place.” Those skilled in the art will appreciate how this may be accomplished and will also understand other ways/mechanisms through which the ballast cover 86 may engage the ballast tray 74.

As noted above, one or more of the LEDs 60 may be positioned such that it protrudes through the ballast cover 86. (This is shown in FIG. 2). Any number of LEDs 60 may protrude through the ballast cover 86. Any type of LED may be used, including LEDs having different levels of brightness and illumination. The exact specifications for each LED will depend upon the particular lighting application. It should be noted that some LEDs provide only low-level (dim) lighting. However, other types of LEDs have been designed that provide bright, high-level lighting. Accordingly, LEDs are not limited solely to low-level lighting. Any type of LED that is capable of providing any output level may be used herein.

U.S. Pat. No. 7,086,747 and U.S. patent application Ser. No. 11/435,945 disclose a type of lighting fixture in which a plurality of additional LEDs protrude through holes in the ballast cover. At taught in these patents, the LEDs may also protrude through holes in any illumination surface that is found in the apparatus. As noted above, this prior patent and this prior patent application have been expressly incorporated herein by reference. In some of the present embodiments, the ballast cover 86 which includes these LEDs may be used as part of the present lighting fixture 52. Thus, further embodiments of the lighting fixture 52 may be designed in which additional LEDs are added proximate to the fluorescent lights 54. Upon reading and understanding the above-recited patent and patent application, skilled artisans will appreciate and understand how the ballasts, ballast tray covers, and/or lighting fixtures taught in these references may be used and incorporated herein.

In those embodiments in which the LED 60 is added to the ballast cover 86, it should be noted that this LED 60 is visible when looking at the finished side of the light fixture 52. The LEDs 60 may also protrude through an illumination surface in the lighting apparatus. Those of skill in the art will appreciate how this may be implemented. In some embodiments, this may involve changing the shape of the cover 70 (i.e., making the cover smaller, transparent, etc.) so that the ballast tray 86 and the LED 60 are visible.

As shown in FIG. 2, the LEDs 60 may communicate with the ballast 100. The ballast 100, as used herein, refers to the multi-functional ballast 100 outlined herein. More particularly, the LEDs 60 communicate with the multi-functional ballast 100 that is added to the ballast tray 74. As the LEDs 60 are generally “low voltage” devices, the LEDs 60 are in low-voltage communication with the multi-functional ballast 100. This low-voltage communication between the LEDs 60 and the multi-functional ballast 100 may occur via low voltage leads. Specifically, these leads 94 may be low-voltage wires which are known in the art. One end of the leads 94 is connected to the multi-functional ballast 100, whereas the opposite end of the lead 94 is connected to the LED 60. Of course, other ways of having the LEDs 60 be in low-voltage communication with the multi-functional ballast 100 are also available. The LED 60 on the ballast tray cover 86 may similarly communicate with the multi-functional ballast 100. Some of these embodiments may include configuring the LEDs 60 such that they communicate with the multi-functional ballast 100 via a wireless protocol, such as RF. In these embodiments, the multi-functional ballast 100 (or ballast tray 74) may include a wireless receiver that would receive wireless signals from the LEDs 60. Another embodiment could consist of a bar, to which LEDs are mounted. This bar could be made of aluminum or other materials. This bar could then be mounted to any illuminating surface of an fluorescent fixture. These LEDs would then complete the retrofit of a fluorescent fixture to include low voltage LEDs. The bar could be attached to the illuminating surface by many means.

In some embodiments, the leads 94 may have various sizes and lengths. The leads 94 may be flexible and/or easily bendable. By having the leads 94 be flexible and adjustable in length, the occupant can easily adjust the position of LEDs 60 as desired. For example, by cutting the leads 94, the LEDs 60 may be positioned in the ceiling (such as in a ceiling tile). The leads 94 may also be adjusted such that the LEDs 60 are positioned above a fire extinguisher, above a workstation, above a desk, above a copy machine, etc. In positioning the LED in the ceiling, a hole will generally be drilled and then an LED fixture would be inserted into the hole. (The fixture is described in detail herein). The fixture will permanently position the LED. A finished plastic or metal member (or plate) is part of the fixture and is the finished member of the fixture. This completes the fixture and improves the visual décor of the fixture. In other embodiments, the leads 94 may be positioned behind the finished side of the wall (or behind a baseboard or otherwise configured so that they are not noticeable/visible). Of course, by positioning the leads 94 behind the wall, a small hole must be made in the wall in order connect the lead 94 to the LED 60. Again, in making this hole in the wall, an LED fixture would then be inserted into the hole. The LED fixture would have a finished member to improve the décor. The LEDs 60 may be positioned at any location on the wall or even along the floor. In other embodiments, a portion of the lead 94 may be strung under the floor (or otherwise out of the way), thereby allowing the occupant to position the LEDs 60 at any location within the room (if desired). By positioning the leads 94 behind the finished side of the wall, the leads 94 will not interfere with the interior décor of the room.

In some embodiments, the user may desire to change and/or modify the number of LEDs 60 that are being used. Accordingly, the lighting system may include one or more plugs 96 and the end of the lead may include a jack 98. The jack 98 may be plugged into the plug 96 for quick and easy engagement. Once the jack 98 has been plugged in, the LED 60 (which is located at the other end of the lead 94) is coupled to the lighting fixture 52. Information regarding the use of plugs 96/jacks 98 is found in U.S. patent application Ser. No. 11/455,604, which application is, as noted above, incorporated herein by reference. Thus, by plugging the leads 94 with the jacks 98 into the appropriate plugs 96, the desired number of LEDs 60 may be obtained.

As noted above, the lighting fixture 52 further includes a multi-functional ballast 100. In some embodiments, the size of the multi-functional ballast 100 may be approximately equal to the size of a conventional T8 ballast. Other sizes and/or shapes for the multi-functional ballast 100 are also possible. As is known in the art, the multi-functional ballast may include circuitry that allows the lighting fixture 52 to illuminate upon receiving voltage from a voltage source. Other voltage sources may also be used. The multi-functional ballast 100 includes switching circuitry which allows for illumination of LEDs 60 and the fluorescent lights 54. A variety of different electronic components may be used in forming the circuitry of the multi-functional ballast 100, including wires, wiring, circuit boards, resistors, capacitors, printed circuit board, and other circuit components. FIG. 2A is a block diagram that illustrates the multi-functional ballast 100, and some of the circuitry and functions of the circuitry used therein. Of course, other embodiments of the circuitry may also be used, as would be appreciated by those skilled in the art. Those skilled in the art will appreciate how to form these types of circuits.

As described above, the multi-functional ballast 100 allows the use of both fluorescent lights 54 and LEDs 60. The user will determine whether the LEDs 60 or the fluorescent lights 54 will be illuminated. Of course, in order for such illumination to occur, there must be a voltage source. Accordingly, as shown in FIG. 2A, the multi-functional ballast 100 will communicate, i.e., draw power, from the building's AC voltage source 104. This AC voltage source 104 is part of the building's electricity supply obtained from the local power company, local municipality, etc. This AC voltage source 104 provides AC voltage to the multi-functional ballast 100. This AC voltage supplied by the voltage source 104 may be used to illuminate the fluorescent lights 54. This AC voltage supplied by the voltage source 104 may be used to illuminate the LEDs 60.

A switching circuit 116 may also be added to the multi-functional ballast 100. In some embodiments, the switching circuit 116 may be similar to that which is disclosed in the patent/patent applications that were incorporated by reference herein, including U.S. patent application Ser. No. 11/435,945 and/or U.S. Pat. No. 7,086,747. In some embodiments, the ballast 100 may contain control lines 51 that can be controlled by many means. For example, control lines may be used to connect various ballasts together. In these embodiments, one switch would control all of the ballasts simultaneously such that all of the ballasts would switch from high voltage fluorescent lights to low voltage LEDs at the same time. Other embodiments will have the control lines for each specific ballast separately controlled via the control line(s). These control lines may be wires or other known mechanisms/means.

The switching circuit 116 may also be designed to switch between high voltage and low voltage. The switching circuit is inside the ballast 100. Specifically, the switching circuit 116 is designed such that when the fluorescent lights 54 are turned on, the multi-functional ballast 100 is operated at high voltage (or at a higher voltage associated with the fluorescent lights 54). The switching circuit 116 provides the necessary resistance, voltage, etc. to the fluorescent lights 54 to illuminate these lights 54. Of course, the AC voltage source 104 provides the power necessary for this illumination. When the switching circuit 116 operates at “high voltage” and illuminates the fluorescent lights 54, the switching circuit 116 ensures that the LEDs 60 (which are low voltage devices) are turned off.

As explained above, the switching circuit 116 is also designed such that the user can turn off the fluorescent lights 54 and then turn on the LEDs 60. When the user turns off the fluorescent lights 54, the switching circuit 116 switches the multi-functional ballast 100 so that the ballast operates at a “low voltage,” i.e., the voltage associated with the LEDs 60. Accordingly, the switching circuit 116 turns off the fluorescent lights 54 and produces the voltage, resistance, current, etc. necessary to illuminate the LEDs 60. Of course, the AC voltage source 104 or DC voltage from the batteries provides the power necessary for this illumination. The switching circuit 116 may also be designed to turn off both the LEDs 60 and the fluorescent lights 54 (i.e., both of the light sources will be “off”).

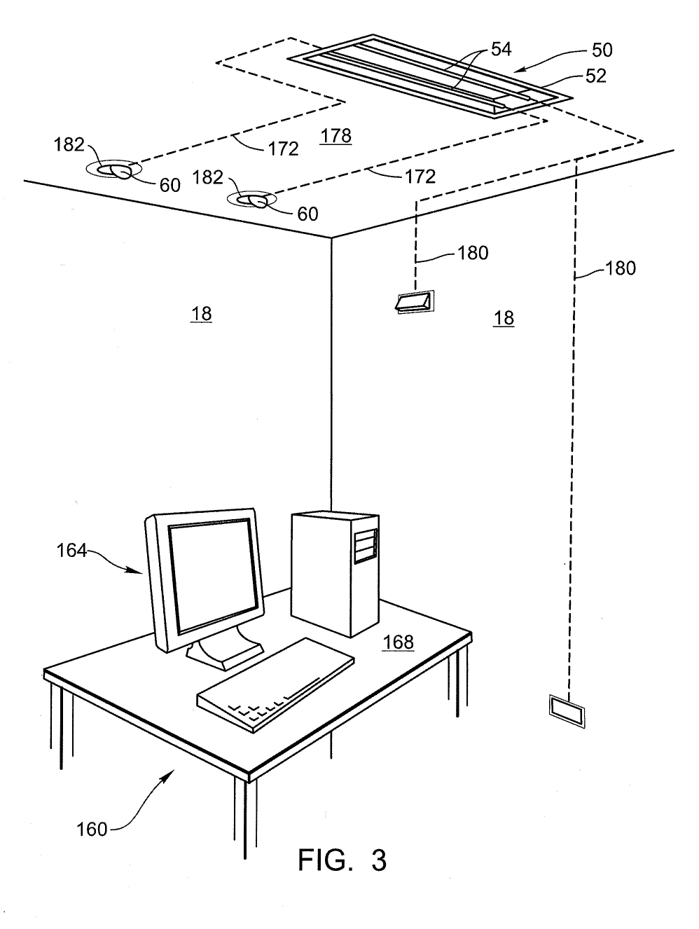

As described above, the user will signal the switching circuit within the multi-functional ballast 100 to switch between the high voltage fluorescent lights 54 and the low voltage LEDs 60 via the switch 66. As shown in FIG. 3, the switch 66 is a RF device. Accordingly, the multi-functional ballast 100 may include a receiver 136 that receives the RF signals from the switch 66. The receiver 136 communicates with the switching circuit 116 inside the ballast 100 so that the LEDs 60 or the fluorescent lights 54 will be turned off/on in accordance with the user's commands.

A battery 112 may also be used with the multi-functional ballast 100. In fact, in some embodiments, the battery 112 is housed within the multi-functional ballast 100. Existing fluorescent lighting systems used in emergency lighting systems have large, separate batteries that are distinct from the ballast. Accordingly, such systems are difficult to install. The present embodiments may have the battery 112 (and battery charger) housed within the multi-functional ballast 100, yet at the same time, the multi-functional ballast 100 is about the same size as a conventional T8 ballast. Such sizing of the present multi-functional ballast 100 makes it less bulky, easier to install, and/or easier or less expensive to ship/manufacture.

In some embodiments, the switching circuit 116 may be coupled to a battery 112 such that when the LEDs 60 need to be turned on, the switching circuit 116 causes the battery 112 to supply DC voltage to the LEDs 60. At the same time the battery 112 is supplying DC voltage, it may also be recharged (at an equal or greater rate) by the battery charging circuit 108, thus ensuring that there is a sufficient voltage to the LEDs 60.

In some embodiments, the switching circuit 116 couples the battery 112 to the LEDs 60 if and/or when the switching circuit 116 is not receiving AC voltage from the AC voltage source 104. Again, this coupling upon loss of AC voltage ensures that the LEDs 60 will illuminate in the event that power is lost to the building. In other embodiments, the switching circuit also couples the battery 112 to the LEDs 60 if and/or when the switching circuit 116 receives an alarm signal. This alarm signal may be produced by the detectors 30 (shown in FIG. 1) which indicate an emergency situation. In other embodiments, the battery 112 will provide DC voltage to the LEDs 60 if a signal is received, such as from a computer, a monitoring station, or other similar feature that is used in conjunction with the present lighting systems.

The AC voltage source 104 is coupled to a battery charging circuit 108. As used herein, the term “coupled to” does not require a direct connection. Rather, “coupled to” simply requires that electricity may flow between the two elements. Thus, AC voltage source 104 is coupled to the battery charging circuit 108 such that electricity may flow between the AC voltage source 104 and the battery charging circuit 108.

In turn, the battery charging circuit 108 is coupled to a battery 112 (or batteries). The battery(ies) 112 is capable of providing voltage, such as DC voltage to the LEDs 60. In other embodiments, each LED 60 may be coupled to its own distinct battery 112, whereas in further situations, a centralized battery system may be used. The battery 112 (or batteries) may be designed to have sufficient power such that they may illuminate the LEDs 60 for a period of at least ninety (90) minutes after the power to the building is lost.

As its name suggests, the battery charging circuit 108 is designed to charge the battery 112. In other words, the battery charging circuit 108 takes the AC voltage provided by the AC voltage source 104 and uses it to charge the one or more batteries 112, thereby ensuring that the one or more batteries 112 remain at or near full capacity. Those of skill in the art are familiar with the electronic components necessary to recharge the battery 112. By maintaining the batteries 112 at or near full strength, the battery 112 will be capable of illuminating the LEDs 60 in the event that the AC voltage source 104 is unable to provide AC voltage. As noted above, the AC voltage source 104 may fail to provide voltage if the “power is out,” if there is an emergency, etc. Thus, by maintaining the battery 112 at or near full strength, the battery 112 allows the LEDs 60 to provide illumination, even if the power is lost.

As noted above, systems may be designed such that a different switch 66 is used for each of the multi-functional ballasts 100. Accordingly, each switch may include multiple input devices (such as buttons) that will control operation of the multi-functional ballast 100. For example, one button may be used to turn on the fluorescent lights 54 (and simultaneously turn off the LEDs 60), another button used to turn on the LEDs 60 (and simultaneously turn off the fluorescent lights 54), and a third button to turn off both the LEDs 60 and the fluorescent lights 54. In some embodiments, the buttons may be designed with pre-determined settings. For example, in one setting, the user may push a particular button and one or more of the fluorescent lights 54 will illuminate. By pressing another button, one or more of the LEDs 60 may be illuminated. Other possible combinations of turning on/off the LEDs 60/fluorescent lights 54 are also possible.

The exact number of buttons will depend upon the particular embodiment and the number of fluorescent lights 54/LEDs 60 being used. For example, embodiments may be designed the LEDs 60 are divided into “zones” and pushing particular buttons will cause different zones of LEDs 60 to illuminate. (While these zones of LEDs 60 are illuminated, the fluorescent lights 54 remain off). Similarly, embodiments may be designed the fluorescent lights 54 are divided into “zones” and pushing particular buttons will cause different zones of the fluorescent lights 54 to illuminate. (While these zones of fluorescent lights 54 are illuminated, the LEDs 60 remain off). Those skilled in the art will understand how to configure the switch 66 so that it can turn on/off one or more of the fluorescent lights 54/LEDs 60, as desired.

Although the use of RF signals may provide a convenient protocol for communication between the receiver 136 and the switch 66, other types of wireless communication protocols (or wireless communication methods) may also be used. Further embodiments may also be made in which the switch 66 communicates with the receiver via wires, cables, or other similar mechanisms. These wires, cables, etc. may be positioned behind the walls, ceiling, floor, etc. in order to hide such features from the occupants' view.

Referring now to FIG. 3, a perspective view illustrates a workstation 160 that incorporates the lighting apparatus 50 of the present embodiments. (As shown in FIG. 3, the cover 70 of the lighting apparatus 50 has been removed for clarity.) The workstation 160 may include a computer 164 that is positioned at a desk 168. This workstation 160 may be located in the office 22c (shown in FIG. 1), at one of the cubicles 36 (shown in FIG. 1), at the reception desk 32 (shown in FIG. 1), or at other locations in the planned area 10 (shown in FIG. 1).

As can be seen in FIG. 3, the lighting fixture 52 with the fluorescent lights 54 is positioned proximate the workstation 160. These fluorescent lights 54 provide work/task lighting to the area proximate the workstation 160. However, as shown in FIG. 3, the user desires optional illumination while working at the computer 164. As such, the LED 60 has been used in conjunction with the lighting fixture 52 via a lead 94. The LED 60 is in low-voltage communication with the multi-functional ballast 100 (shown in FIG. 2). A hole 182 may be added in the ceiling 178 to accommodate the LED 60, and the LED fixture will be inserted into the hole to make the fixture visually appealing.

By positioning the LED 60 over the computer 164, the user may turn the LED 60 on (via the controller 66 of FIG. 1) to provide work/task lighting while working at the workstation 160. Likewise, a different user may desire higher levels of lighting while working at the workstation 160. Accordingly, this user may simply turn on the overhead fluorescent lights 54 and turn off the LEDs 60. In order to further adjust the level of illumination proximate the workstation 160, additional LEDs 60 may be used, as desired.

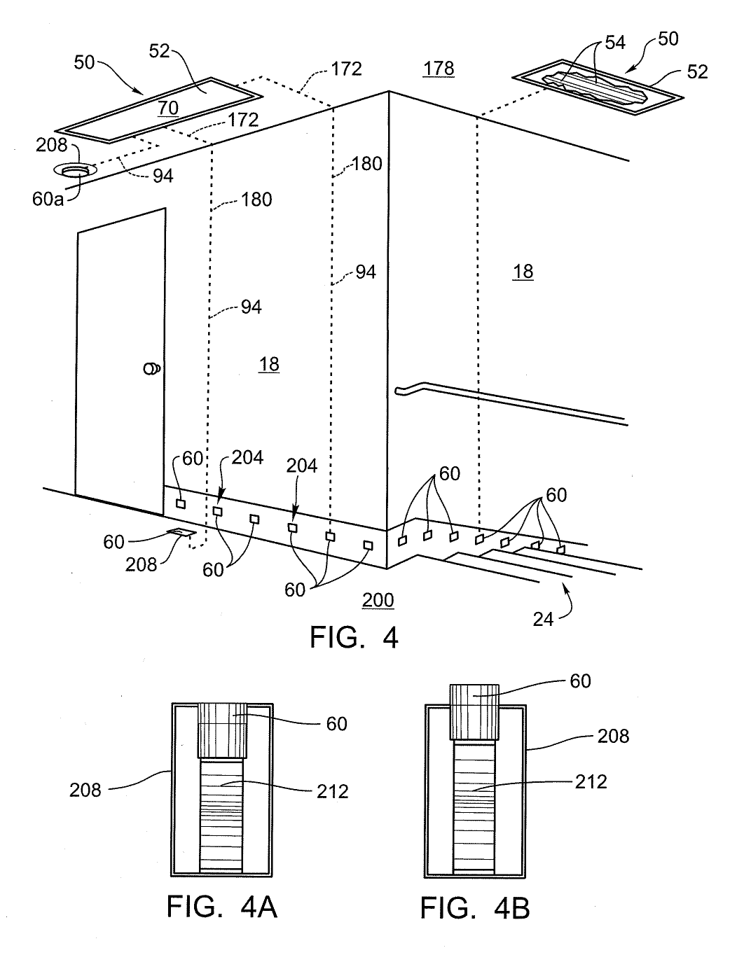

Although FIG. 3 illustrates the use of the LED 60 over a workstation 160, the LED 60 may be positioned anywhere throughout the planned area 10 as desired. For example, LEDs 60 is shown in the wall 18. The LED 60 positioned on the wall that is closest to the floor may provide emergency lighting, as described in greater detail in FIG. 4. Examples of locations where these LEDs 60 may be used include over/proximate fire extinguishers, over/proximate stairways, over/proximate exits, over/proximate the copy machine (or other office equipment), in foyers, in reception areas, in offices, over/proximate cubicles, etc.

In some embodiments, the fluorescent lights 54/light fixtures 52 are used with a ceiling 178 that is composed of one or more tiles. Such ceiling tiles are conventional and known in the art. In some embodiments, these ceiling tiles may be readily cut or otherwise modified to include the LED fixture.

As shown in FIG. 3, embodiments may be designed in which the LED 60 is positioned directly in the ceiling 178. Other embodiments may be designed in which the LED 60 contacts the ceiling 178. Other embodiments are designed in which the LEDs 60 are positioned on the ballast tray 86 (shown in FIG. 2). Further embodiments may be designed in which the LED 60 is housed within a housing that is positioned in the ceiling such that the LED 60 is contained by the housing.

Referring now to FIG. 4, a perspective view illustrates the use of the lighting apparatus 50 proximate a wall 18 of the planned area 10 (shown in FIG. 1). The lighting apparatus includes the lighting fixture 52. As described above, the lighting fixture 52 comprises fluorescent lights 54. The fluorescent lights 54, when turned on by the switch 66 (not shown in FIG. 4) provide light and illumination proximate the wall 18.

An occupant may want to provide optional lighting to this area proximate the wall 18. Accordingly, the user may choose to use one or more LEDs 60 to increase the illumination of this area. The LED 60 is in low-voltage communication with the ballast 100 (shown in FIG. 2) found in the lighting fixture 52. The LED 60 is coupled to the lighting fixture 52 via a lead 94.

The LEDs 60 are positioned at the end of the lead 94. The lead 94 may wind along behind the wall 18, thereby causing the LED 60 to become positioned at or proximate the floor 200. Other embodiments may also be made in which the LED 60 is positioned at any location or height on the wall 18. Further embodiments may be designed in which the LED 60 is positioned on the floor 200 proximate the middle or a middle portion of the room. In such embodiments, a portion of the lead 94 may extend along or underneath the floor 200.

The LED 60 will be its own separate fixture. This fixture will be positioned in a hole 204 in the wall 18 and/or the floor 200. However, this fixture may be positioned within this hole 204 so that the front edge of the LED 60 is flush with the floor 200 and/or the wall 18. In some embodiments, the fixture of the LED allows the LED 60 to be hidden and will not be an obstacle to occupants walking in this area of the room.

Embodiments may be constructed in which the LED is housed within a housing 208 such that the LED 60 is completely concealed. This LED is shown in FIG. 4 as LED 60a. This housing 208 may be made of plastic, brass or other materials. In some embodiments, only the housing 208 would be visible to the occupant when the LED 60 is turned off. However, when the LED 60 is turned on, the LED 60 unsheathes or “pops-out” of the housing 208. Once unsheathed, the LED 60 can provide illumination. A pop-out mechanism 212 may be required to allow the LED 60 to unsheathe from the housing 208. Any device, like that is capable of causing the LED to pop out, such as a solenoid and the like, may be used as the mechanism 212. The “pop-out” features of the LEDs 60 are shown in FIGS. 4A and 4B. Those of skill in the art will appreciate how to construct the LED 60, the housing 208 and/or the spring 212 in order to allow the LED 60 to unsheathe at the desired time. In some embodiments, the LED 60 may be unsheathed or allowed to “pop-up” using technology similar to that which is currently used in “pop-up” sprinklers in the lawn/garden industry. Embodiments may also be designed such that when the LED 60 is not longer illuminated, the LED 60 may return to its sheathed, stowed configuration. When the LED 60 is sheathed, it is housed within the housing 208 so that it is protected and will be ready for future use.

It should be noted that in FIG. 4, the “pop-out” LED 60a is positioned on the ceiling. Other embodiments may be designed in which pop-out LEDs 60a are positioned on the wall 18, or at other locations in the room/building. An LED that is flush with the floor may be positioned on the floor.

Although FIG. 4 shows multiple LEDs 60 being positioned proximate the floor 200/wall 18, only one LED 60 may be used. For example, embodiments may be constructed in which a series of LEDs 60 are positioned along the floor 200/wall 18, thereby creating a pathway that leads to or indicates an exit. In some embodiments, these LEDs 60 may be positioned about eighteen (18) inches above the floor and would direct light to the floor. Accordingly, in the event of a power outage or emergency situation, the LEDs 60 may illuminate to show the occupants the location of emergency exits, thereby helping the occupants to properly and safely exit the building/room. Further, the LEDs 60 may be designed to maintain illumination for multiple hours after the power is lost to the building or after the emergency condition is detected. If emergency personnel or firefighters enter the room, the LEDs 60 will provide illumination/light to these persons, thereby facilitating the firefighters/emergency personnel in rescuing trapped individuals. Also, by lighting the room for the firefighters/emergency personnel, the firefighters/emergency personnel may avoid obstacles or other dangerous conditions that may exist in the area. Light in this room may also prevent the firefighters from tripping while performing their duties. As such, the lighting apparatus of the present embodiments may facilitate firefighters in performing their emergency response/rescue duties.

It should be noted that in FIGS. 3 and 4, the leads 94 may be attached to the multi-functional ballast 100. This may occur by having the end of the lead 94 be inserted into a receptor in the ballast 100. Further, the end of the lead 94 that attaches to the LED 60 may similarly be connected using a method of jacks/plugs. In other words, the LED 60 may include a plug that receives a jack that is positioned on the lead 94. Such teaching regarding the connection of the leads 94 to the LEDs 60/lighting fixture 52 is not limiting. Other ways for connecting the lead 94 to either the LEDs 60 or lighting fixture 52 may be used. Of course, some of these methods for connecting the lead 94 to either the LEDs 60 or lighting fixture 52 may be designed such that current (electricity) may flow from the lighting fixture 52, through the lead 94 and to the LED 60.

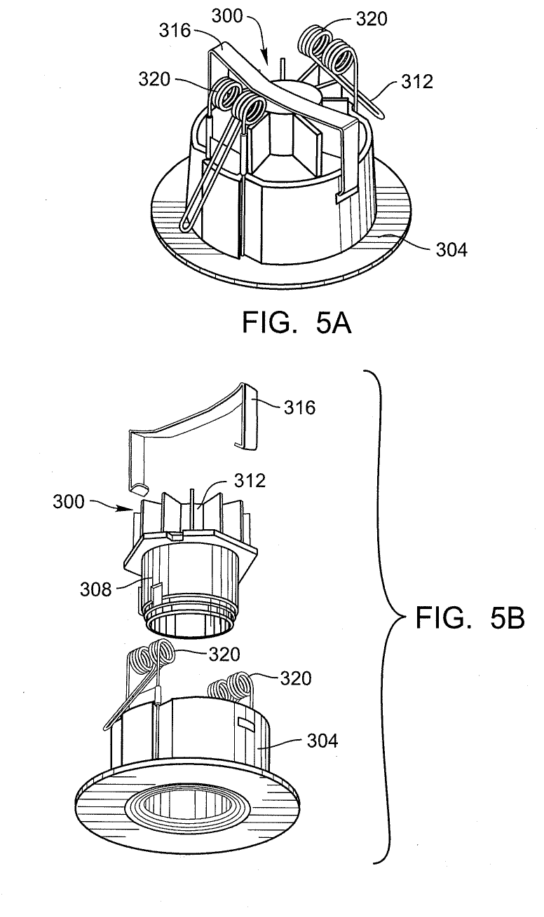

Referring now to FIGS. 5A and 5B, an embodiment of an LED fixture 300 is illustrated. This LED fixture 300 may be used and mounted to the ceiling, the floor, the walls, as taught herein. The LED fixture 300 is but one example an LED fixture that may be used herein. Other types of LED fixtures may also be used.

The LED fixture 300 includes a plastic or metal housing 304. This housing is designed to be visually appealing. The housing may fit into the hole added to the wall/floor/ceiling. The LED fixture 300 also may include an LED module 308 and a heat sink 312. The LED module 308 includes an LED lamp (not shown). As noted above, any type of LED lamp or LED light may be used including LEDs of all types, illumination levels, brightness levels, etc.

A clip 316 and/or one or more springs 320 may also be used as part of the LED fixture 300. The springs 320 and/or the clip 316 may engage the housing 304. The springs 320 and/or the clip 316 may operate to hold the fixture 300 in place so that when installed, the fixture 300 is securely and/or permanently attached to the ceiling/floor/wall.

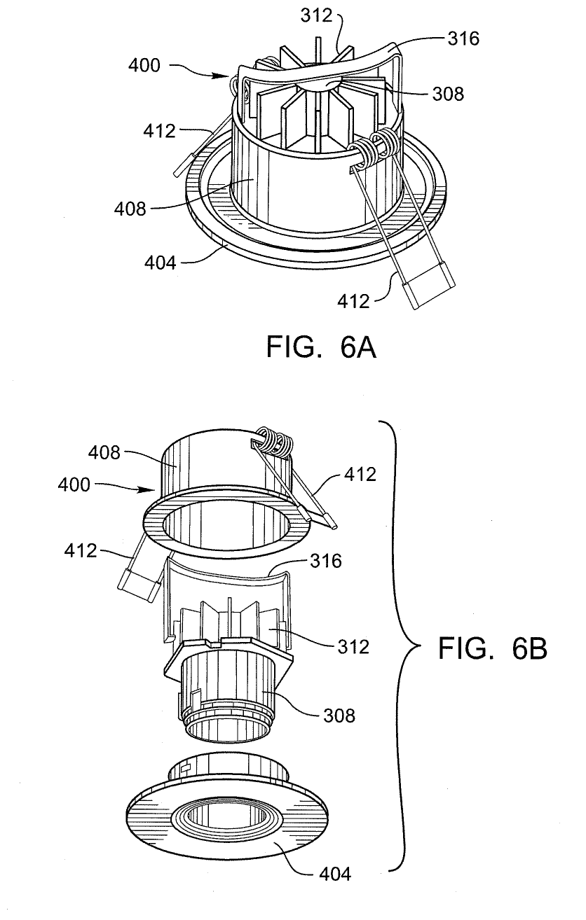

Referring now to FIGS. 6A and 6B, a different embodiment of a LED fixture 400 is illustrated. The LED fixture 400 is similar to that which is shown above. In this embodiment, the LED fixture 400 will include a clip 316, and LED module 308 and a heat sink 312. The LED fixture 400 may also include a plastic or metal rim 404. The rim 404 is visible to the occupant. The rim 404 is designed so as to be visually appealing. The rim 404 is positioned in the hole that is cut in the ceiling/wall/floor.

A housing 408 may also surround the LED module 308. The housing 408 is made of metal or plastic and contacts the rim 404. The housing 408 fits into the hole added to the wall/ceiling/floor. One or more springs 412 engages the housing 408. However, as shown in FIGS. 6A and 6B, a portion of the springs 412 extend below the rim 404 (when installed). The springs 412 may engage the rear (non-visible) side of the wall/ceiling/floor. The springs 412 and the clip 316 securely and/or permanently position in the installed location.

Referring now generally to all of the Figures, those of skill in the art will recognize that the present embodiments may be used as a night lighting system. Specifically, after hours or in low use areas such as stair wells, the owners of the building 12 may wish to reduce the voltage of the lights in the planned area 10. This is because many of the workers will have gone home.

Moreover, the present embodiments allow LEDs 60 to be positioned directly over the worker's workstation, as discussed above. This arrangement allows provides customized directional lighting for the worker. Thus, the present embodiments would allow an installer to retro-fit the present embodiments into currently used fluorescent light systems 54. Specifically, an installer could replace the existing ballast with the multi-functional ballast 100 of the present embodiments. Once this has been replaced, the fluorescent light, the cover, and/or other parts of the existing lighting system used in the building would then be reused. As part of this retro-fit process, one or more LEDs 60 may (or may not) also be installed, as taught herein. In other embodiments, the owner may choose to retro-fit with a ballast 100 that includes LEDs 60 installed therein (i.e., LEDs 60 that protrude through the cover 86). After such an installation process, the building owner would then enjoy all of the advantages (and cost savings) of the present lighting system and multi-functional ballast, but would not be required to completely re-wire the building or install a new lighting system. Of course, use of the LEDs 60 provide light for workstations is an energy saving mode versus conventional fluorescent lighting. Thus, if the workers use the LEDs 60 rather than the fluorescent lights 54, the overall electrical bill will likely decrease.

In some embodiments, the building owner may choose to change or update some of the ballasts used in the lighting system. For example, as part of the retrofitting process, the owner may choose to update a T12 to a T8 ballast or from a T8 ballast to a T5 ballast. Thus, by retro-fitting the building with the multi-functional ballasts 100, the building owner may be able to replace older technologies with the fluorescent lights 54/LEDs 60.

Further, the present embodiments of a lighting apparatus 50 may also be used as a security lighting system. By turning such lights on and off throughout the day or night, it will give the impression to a would-be perpetrator/thief that the building 12 is being used and occupied, even when the building 12 is indeed empty. However, if a perpetrator thinks that the building 12 is occupied, he or she may be less likely to rob/vandalize the building 12 as he/she will fear that he/she will be caught by the building occupants. Further, the present lighting systems may be used with computer controlled management systems, timers, motion sensors, etc., which could switch between fluorescent lights 54 and the LEDs 60 automatically or on command.

The present embodiments also allow for a battery backup system completely housed within a single ballast. The present multi-functional ballast 100 combines the technology of a regular electronic T12, T8, or T5 ballast with the switching circuit 116 that switches between LEDs 60 and fluorescent lights 54. This multifunctional ballast may replace existing electronic ballasts as well as any other conventional emergency support ballast used for existing emergency fluorescent fixtures. The use of battery in a single location may simplify construction of the system. However, in other embodiments, a centralized battery system may be used, if a collection of multi-functional ballasts 100 are used together. This centralized battery system may illuminate multiple ballasts at the same time and may provide the option of running extended periods with low-voltage LEDs 60. The intent would be to provide low-voltage, work/task lighting (via the LEDs 60) during a workday and then re-charge the battery system during off peak-hours, so that electricity could be purchased at lower rates. This would reduce peak power use and allow a more comprehensive energy management system. In other embodiments, the battery or battery system may be located separate from the ballast 100.

The simple compact design of the present multi-functional ballast 100 may eliminate the need for bulky battery backup ballasts that take up all the space under the ballast tray cover 86. Also, there may be no extra wires to deal with, and the multi-functional ballast 100 is approximately the same size as the electronic ballast it would replace. Installation is easy; requiring no new wiring scheme and the wiring for the fluorescent fixture may be the same as conventional electronic ballasts. Thus, the multifunctional ballast 100 may take the place of conventional ballast and provide backup lighting capability. It may also be used to specifically replace existing emergency fluorescent fixtures, which depend only on high-voltage ballasts and a large battery pack, as an energy-savings mechanism.

In other embodiments, the lighting fixture 52 is designed to reduce power consumption in areas that have 24 hour mandated lighting, such as stairwells. When people are not present in the area, the illumination of this area may be accomplished via the low-voltage LEDs 60. However, when people are present, the LEDs 60 may be turned off and the fluorescent lights may be used to provide illumination. The presence of people may be detected via a motion sensor or detector. (This motion detector may be the detector 30 of FIG. 1 which is positioned in the planned area or as part of the light fixture 52). Other embodiments may be designed to turn on the fluorescent lights 54 based upon a timer (or control timer). The multifunctional ballast 100 used with a motion detector 30, would allow low-voltage (LED) operation during normal hours and fluorescent lighting when someone entered the area, thus resulting in substantial electrical savings when the LEDs 60 are active.

Further, the present embodiments also teach a method for providing illumination to an area in an energy-efficient manner. This method may include the step of providing a lighting fixture 52. This lighting fixture 52 may comprise a ballast tray 74, a ballast cover 86, and one or more fluorescent lights 54. The step of positioning one or more LEDs 60 remote from the ballast 100 may also be used. Further, the step of configuring the one or more LEDs 60 is used. This configuring step may involve configuring the LEDs 60 such that LEDs 60 are in low-voltage communication with the ballast 100.

Additional embodiments may be designed in which the method includes the step of having the ballast 100 switch between high voltage and low voltage. Other embodiments may be designed in which the LEDs 60 communicate with the ballast 100 via one or more leads 94. Yet further embodiments may be designed in which a battery 112 provides DC voltage to the LEDs if an AC voltage source 104 fails to provide AC voltage to the ballast tray 74.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An energy-efficient lighting apparatus comprising:
a lighting fixture comprising a multi-functional ballast and one or more fluorescent lights;
one or more LEDs, the one or more LEDs being in low-voltage communication with the ballast, wherein the ballast is configured so that a user can switch between illuminating the LEDs or illuminating the fluorescent lights.

2. The energy-efficient lighting apparatus as in claim 1, wherein the ballast switches between high voltage and low voltage.

3. The energy-efficient lighting apparatus as in claim 2, wherein the ballast switches between high voltage for the fluorescent lights and low voltage for the LEDs.

4. The energy-efficient lighting apparatus as in claim 1, wherein the lighting apparatus further comprises a ballast tray that holds the ballast, wherein the LEDs are connected to a ballast tray via one or more leads.

5. The energy-efficient lighting apparatus as in claim 4, wherein the LEDs protrude through holes in the ballast tray cover or any other illumination surface.

6. The energy-efficient lighting apparatus as in claim 4, wherein the LED are located remote from the ballast tray.

7. The energy-efficient lighting apparatus as in claim 1, wherein the LEDs are configured to be positioned along the floor or a wall of a room.

8. The energy-efficient lighting apparatus as in claim 1, wherein the LEDs are housed within a housing, wherein the LEDs are designed to be unsheathed from the housing upon receipt of a signal.

9. The energy-efficient lighting apparatus as in claim 1, wherein the lighting apparatus is constructed such that individual LEDs or individual fluorescent lights are turned on and off via switching.

10. The energy-efficient lighting apparatus of claim 1, further comprising a battery for supplying power to the LEDs.

11. The energy-efficient lighting apparatus of claim 10, further comprising a switching circuit that couples the battery to the LEDs if the switching circuit is not receiving AC voltage from an AC voltage source.

12. The lighting apparatus of claim 11, wherein the switching circuit couples the battery to the LEDs if the switching circuit is receiving an alarm signal.

13. The lighting apparatus of claim 10, further comprising a battery charging circuit for charging the battery.

14. A method for providing illumination to an area in an energy-efficient manner, comprising:
providing a lighting fixture comprising a multi-functional ballast and one or more fluorescent lights;
providing one or more LEDs; and
configuring the one or more LEDs such that LEDs are in low-voltage communication with the ballast, wherein the ballast is configured so that a user can switch between illuminating the LEDs or illuminating the fluorescent lights.

15. The method for providing illumination as in claim 14, further comprising the step of having the ballast switch between high voltage and low voltage.

16. The method for providing illumination as in claim 14, wherein the LEDs are remote from the ballast and communicate with the ballast via one or more leads.

17. The method for providing illumination as in claim 14, wherein a battery provides DC voltage to the LEDs if an AC voltage source fails to provide AC voltage to the ballast.

18. A multi-functional ballast for a lighting apparatus, the lighting apparatus comprising one or more LEDs and one or more fluorescent lights, the ballast comprising a switching circuit that switches the ballast between high voltage and low voltage, wherein the LEDs are illuminated when the ballast is at low voltage and the fluorescent lights are illuminated when the ballast is at high voltage.

19. The multi-functional ballast as in claim 18, further comprising a battery wholly contained with the ballast, wherein the battery provides DC voltage that illuminates the LEDs in the event of a power outage.

20. The multi-functional ballast as in claim 18 further comprising a ballast tray cover, wherein the LEDs are positioned in the ballast tray cover.

21. A method for providing retrofitting a lighting system to an fluorescent lighting system comprising:
providing a multi-functional ballast and one or more LEDs;
configuring the LEDs such that the LEDs are in low-voltage communication with the ballast;
configuring the existing fluorescent lights to communicate with the ballast; and
configuring the one or more LEDs such that with the ballast, wherein the ballast is configured so that a user can switch between illuminating the LEDs or illuminating the fluorescent lights.

22. A method as in claim 21 wherein the LEDs are located remote from the ballast or are positioned to protrude through a hole in the ballast tray cover.
